(19) United States
(12) Patent Application Publication
(10) Pub. No.: US 2011/0109853 A1
(43) Pub. Date: May 12, 2011

(54) Liquid Crystal Displays with Embedded Photovoltaic Cells

(75) Inventors: Zhibing Ge, Sunnyvale, CA (US); Shin-Tson Wu, Oviedo, FL (US); Wang-Yang Li, Xinhua Town (TW); Chung-Kuang Wei, Taipei City (TW)

(73) Assignees: University of Central Florida Research Foundation, Inc., Orlando, FL (US); Chimei InnoLux Corp., Tainan County (TW)

(21) Appl. No.: 12/940,525

(22) Filed: Nov. 5, 2010

Related U.S. Application Data
(60) Provisional application No. 61/258,785, filed on Nov. 6, 2009.

(51) Int. Cl. G02F 1/1335; H01J 9/00

(52) U.S. Cl. 349/114; 445/24

(57) ABSTRACT

Methods and apparatus for a liquid crystal display with embedded photovoltaic cells for high energy efficiency. The LCD with photovoltaic cell comprises a first linear polarizer, a second linear polarizer, a first and second substrate, a liquid crystal cell formed between two substrates, and a backlight unit at the backplane of the display. Further, the display device has many repetitive pixels in the LC cell, each pixel region comprises a transmissive region that can pass the light from the backlight, and another region that is backlight blocking. A photovoltaic cell is formed on the bottom substrate to substantially cover the backlight blocking region. In one embodiment, the LCD is a transflective display, and in another embodiment, the LCD is a pure transmissive display that relies on backlight for displaying images.

This application claims the benefit of priority to U.S. Provisional Application No. 61/258,785 filed on Nov. 6, 2009.

### FIELD OF THE INVENTION

This invention relates to liquid crystal displays and, in particular, to methods and devices for an energy efficient liquid crystal display with embedded photovoltaic cells for each pixel.

### BACKGROUND AND PRIOR ART

For portable display devices, low power consumption, good sun light readability, thin profile, wide viewing angle, and cost competitiveness are highly desirable. Among these requirements, low power consumption is significantly important for the device performance. For example, with low power consumption, the device can be operated for a longer time between battery charges. Previously, in order to save power consumption, a reflective typed LCD which embeds a reflector into LC cell and uses external ambient light to display images was widely employed. Besides, a reflective LCD also can have good image readability under strong sunlight. However, typical reflective LCDs usually have low contrast ratio (resulting from the surface reflection) and insufficient color saturation, which cannot meet the increasing demand of users. As an alternative, transmissive typed LCDs grow very quickly and take a big share in the mobile displays.

A transmissive LCD sandwiches the LC cell between two linear polarizers and uses a backlight, like a cold cathode fluorescent lamp (CCFL) or light emitting diode to display the image, thus its color is vivid and contrast is high. However, the following drawbacks of a pure transmissive LCD are evident: 1) its power consumption is high, resulting from the dependence of a backlight, and 2) its image is easily washed out by strong outdoor sunlight, as its output light cannot compete with the ambient light there. Therefore, these issues require better solutions to improve the performance of LCDs in portable displays.

As a solution to solve the sunlight readability, a transflective LCD that combines both transmissive and reflective functions in one display is introduced. In a typical transflective LCD, each pixel of the display is usually divided into a separate transmissive region and a separate reflective region as described in Zhu et al, “Transflective liquid crystal displays,” J. Display Technology, 1, pp. 15-29, 2005. Thus the display can exhibit high image quality from its transmissive mode, and good sunlight readability from its reflective mode, in a simultaneous or separate means. Besides, by adjusting the ratio of its reflective region and transmissive region, power consumption can also be reduced, e.g., incorporating a large reflective region (while the backlight is turned off when operating in a reflective mode) can efficiently save the display power consumption. However, the power consumption is reduced in a way that sacrifices the transmissive region that has a high image quality.

As another solution for enhancing the energy efficiency of the display, photovoltaic (PV) cells are incorporated into the mobile LCDs. A first LCD embedding PV cells into a display is shown in FIG. 1 was described in U.S. Pat. No. 6,323,923 issued Nov. 27, 2001. As shown, the reflective LCD 10 has a first transparent substrate 11a, a second transparent substrate 11b, and a liquid crystal layer 15 like a polymer dispersed LC cell sandwiched between these two substrates. Two electrodes 14 and 16, made of transparent conducting materials like indium-tin-oxide (ITO) or indium-zinc-oxide (IZO) are formed in the inner surfaces of the bottom substrate 11a, and the top substrate 11b, respectively, as a means of proving driving electric fields. A photovoltaic cell 13 is formed on the bottom substrate 11b below the liquid crystal layer 15. A metal layer 12, like an aluminum layer, is formed below the PV cell 13 on the bottom substrate as well. Here the metal layer 12 functions as a reflector for the reflective typed LC cell 15 and a conducting electrode together with the other transparent electrode 14 for the PV cell 13, simultaneously. Thus, for the incident ambient light 17, part of it is absorbed by the PV cell 13 and the current generated is connected to the charge the battery (circuits are shown here in the plot), while the left part 18 is reflected back by the reflective electrode 12 to display the image. This approach is the most direct and simplest for combining the PV cell and a LCD. However, several problems still exist: 1) the image quality like contrast and color saturation of this device is low since a PDLC based reflective typed LCD is employed, which limits its application, and 2) the PV cell 13 is not transparent to the whole visible spectrum, in other words, the image color of the display is deteriorated by the color the PV cell as well.

In another approach described in U.S. Pat. No. 7,206,044 issued Apr. 17, 2007, a band pass reflector is introduced to a reflective LCD with a PV cell. The device structure is shown in FIG. 2, where a reflective LCD 20 has a PV cell 25 formed far below the LC cell 24. In this device, a liquid crystal layer 24, like a twist nematic LC cell or a super twist nematic cell, is sandwiched between two substrates 22a and 22b. A top polarizer 21 is formed above the LC cell. Here a special reflector 23 is interposed between the LC cell 24 and the bottom substrate 22a. The reflector 23 is designed to have selective band pass properties for the visible light, for example, it passes blue and red lights but reflects green light. Thus form the incident ambient light 27, part of the light 28 penetrates the reflector 23 and goes further to the PV cell 25 for charging, and the remaining part of the light 29 is reflected back to the viewer for display images. Still, this display fully relies on the reflective LCD for display image, which has a low contrast ratio. And the reflected light has a “single” color (like green) which limits the display only for a monochromatic display application.

As an improvement, in another design disclosed in U.S. Pat. No. 7,339,636 issued Mar. 4, 2008 is shown in FIG. 3. As shown, a switchable transflector is introduced into the display previously described. In one pixel plot of the display 30, a liquid crystal layer 33, sandwiched between two substrates 32a and 32b, is further interposed between two linear polarizers 31a and 31b. A color filter 38 is arranged below the LC cell 33 for producing color of each pixel. An electrically switchable transflector 35 is formed below the bottom linear polarizer 31a, followed by a transparent or semi-transparent backlight 36. Finally a PV cell 37 is formed below all other layers. With this design, the switchable transflector is controlled by a controller circuit between a high reflectivity state and a high transmission state. Thus when the controller switches the transflector to be high transmission (like 70-80% T), the LCD works mainly under transmissive mode, and the backlight unit 36 emits light 41 toward the LC cell 33, and further to the viewer to display the image. While light 42c which takes a large part of the ambient light 42a can penetrate the LC cell all the way to the PV cell 37 at the backplane, most of the light 42b is reflected back to the viewer. When the controller switches the transflector to be high reflectivity (like 70-80% R), the display works mainly in a reflective mode, the backlight is mainly turned off (41 is off now) to save power, and the ambient light 42a then has a large amount of light reflected back at the surface of transflector 35, which is light 42b, but only a small amount of light 42c goes to the PV cell.

As compared to the design using a band pass reflector described in the '044 patent, this method can achieve a true tri-color display in both transmissive and reflective modes, with the help of the color filter 38. However, several problems exist. First, the transflector is far away from the LC cell (separated by a substrate 32a, linear polarizer 31a and other films), thus because the LC cell is usually several microns thick, such a long distance (several hundred micron thickness from the substrate and polarizer) makes the incident light 42a and exit light 42b travel through different pixels, which is called parallax and results in deteriorated images. Besides, because a transflector has both transmission and reflection simultaneously, even working in a transmissive mode with backlight 36 turned on, the small amount of reflection from transflector 35 that has a parallax will affect the image quality as well.

Second, the majority of the charging is accomplished when the transflector is working under a transmissive mode. The efficiency is low, since the overall light transmission after a path from the surface of the top linear polarizer 31b to the exterior surface of the bottom linear polarizer 31a is usually less than 10% in a typical mobile LCD, then further loss after the following stacks finally makes the light to the PV cell less than 4%.

From the analysis of these prior arts, it seems the inclusion of the PV cell is mainly introduced to reflective LCD, and image quality including the contrast ratio of such a display is usually sacrificed. Besides, the light to charge the PV cell is from the ambient lights, while the input efficiency (the amount of light coming to the PV cell surface) is usually low. Better solutions are needed for advanced displays with PV cells.

To overcome the problems with prior art, the present invention provides a device structure that combines the liquid crystal cell and a photovoltaic cell together for high energy efficiency. The present invention is different from prior arts in that, in some embodiments of this display device, the PV cell is formed in a transflective LCD, and the PV cell is below the black matrix region and regions with reflectors of the display. The light for charging the PV cell primarily comes from the backlight, and only a small amount is coming from the external ambient light. In the present invention design, light efficiency is improved, and the display can have high image quality by using a transmissive mode, and good sunlight readability using the reflective mode. Additionally, the display can have reflective functions with high contrast that is parallax free. In another embodiment, the PV cell is formed in a pure transmissive LCD, which is designed to substantially cover the regions that backlight cannot transmit in each LC aperture.

### SUMMARY OF THE INVENTION

A primary objective of the invention is to provide devices and methods for a LCD with photovoltaic cells that can have a high energy efficiency, which could make the display device a longer working time than conventional displays without PV cells.

A secondary objective of the invention is to provide devices and methods for a LCD with photovoltaic cells that can have a transmissive function that can provide high image quality including high contrast, high color saturation, and a functional reflective mode that has a good sunlight readability of displayed images.

A first embodiment provides a transflective liquid crystal display with a photovoltaic cell that includes a lower transparent substrate having a first linear polarizer laminated on an exterior surface, an upper transparent glass substrate having a second linear polarizer laminated on an exterior surface, the upper substrate positioned adjacent to a viewer and a liquid crystal layer sandwiched between the lower and upper substrates. The transflective display also includes a backlight unit adjacent to the exterior of the lower substrate, plural pixel regions between the upper and lower substrates. Each pixel includes a first sub-region having a data line and a gate line connected to a thin-film-transistor to switch the pixel, a storage capacitor and a reflector between the first substrate and the liquid crystal layer, the reflector reflecting ambient light to display images, a photovoltaic cell formed in the first sub-region between the lower substrate and the reflector, the light from the backlight in the first sub-region striking the photovoltaic cell to generate current and voltage for charging a battery of the liquid crystal display, and a second sub-region having transparent electrodes on at least one of the upper and lower transparent substrates for driving the pixel, the second sub-region transmitting light from the backlight unit through the liquid crystal layer for displaying images while part of the ambient light passing the through the second sub-region toward the backlight unit is scattered and redirected to the photovoltaic cell.

The photovoltaic cell can be made of active photovoltaic materials including amorphous silicon materials in a single p-n junction or multiple p-n junction structure, the said transparent electrodes in the transmissive region can be made of conductive materials including indium-tin-oxide and indium-zinc-oxide; the reflector can be made of one of aluminum and silver; liquid crystal cell can be a twist-nematic cell, a homogeneous cell, or a vertical alignment cell; and liquid crystal cell can include at least one compensation film selected from a group consisting of discotic film, uniaxial film, and biaxial film. The ratio between the first sub-region and the sub-region is adjusted from approximately 2:8 to approximately 8:2.

Another embodiment provides a method for fabricating the transflective liquid crystal display with an embedded photovoltaic cell by providing a first and second substrate with a linear polarizer laminated on an exterior surfaces, a color filter on the second transparent substrate and a liquid crystal layer between the substrates as a liquid crystal cell having a plurality of pixels. Each pixel includes a transparent pixel electrode on an interior surface of the first transparent substrate and a transparent common electrode on an interior surface of one of the first and second transparent substrates, and a thin-film transistor, a gate line and a data line on the first substrate, the gate line and the data line each connected to one of the source and the drain of the thin-film-transistor. A photovoltaic cell is formed on a portion of the first transparent substrate in each pixel region to form a reflective sub-region with a reflector between the photovoltaic cell and the liquid crystal layer. A backlight unit is positioned below the first substrate so the light emitted from the backlight unit strikes the photovoltaic cell in the reflective sub-region and transmitting through the liquid crystal cell the remaining transmission sub-region. The method includes depositing an alignment layer on the interior surfaces of the first and second substrates, depositing a color filter on the second transparent substrate, and connecting the data line and gate line to an external driving circuit and connecting the photovoltaic cell to an external charging circuit to charge a battery.

A second embodiment provides a transmissive liquid crystal display with a photovoltaic cell including a lower transparent substrate, a backlight unit positioned adjacent to the exterior surface of the lower substrate, an upper transparent substrate positioned for viewing by a viewer with linear polarizers laminated on an exterior surface of the substrates, and a liquid crystal layer between the lower and upper substrates forming a plurality of pixel regions between the upper and lower substrates. Each pixel region includes a first sub-region having a data line and a gate line each connected to one of a thin-film-transistor drain and source and a storage capacitor, a black matrix between the upper substrate and the liquid crystal layer covering a portion of each pixel to block light from the backlight unit, a photovoltaic on the lower substrate aligned with the black matrix to absorb light from the backlight unit, and a second sub-region having transparent pixel and common electrodes on at least one of the lower and the upper substrate for driving the liquid crystal cell and transmitting light incident from the backlight unit through the liquid crystal cell to display images, the ambient light passing through the second sub-region of the pixel scattering with a portion of the scattered light striking the photovoltaic.

The photovoltaic cell can be made of active photovoltaic materials including amorphous silicon materials in a single p-n junction or multiple p-n junction structure, the said transparent electrodes in the transmissive region can be made of conductive materials including indium-tin-oxide and indium-zinc-oxide; the reflector can be made of one of aluminum and silver; liquid crystal cell can be a twist-nematic cell, a homogeneous cell, or a vertical alignment cell; and liquid crystal cell can include at least one compensation film selected from a group consisting of discotic film, uniaxial film, and biaxial film.

Another embodiment provides a method for fabricating the transflective liquid crystal display with a photovoltaic cell including constructing a liquid crystal cell having a first substrate and a second substrate, laminating a first and second linear polarizer on the exterior surface of the substrates and forming a plurality of pixels between the first and second substrate each pixel having a thin-film-transistor and a data line and a gate line, forming transparent pixel electrodes on the first substrate and a transparent common electrodes on one of the substrates, connecting the data line and the gate line to one of the source and drain of the thin-film-transistor and connecting pixel electrode to the gate of the thin-film-transistor; forming a photovoltaic cell on a portion of the first transparent substrate in each pixel region; depositing black-matrix on the second transparent substrate; interposing a liquid crystal layer between the first substrate and the second substrate; and disposing a backlight unit below the first transparent substrate, the photovoltaic converting part of the backlight emission into electrical energy.

Further objects and advantages of this invention will be apparent from the following detailed description of preferred embodiments which are illustrated schematically in the accompanying drawings.

### BRIEF DESCRIPTION OF THE FIGURES

FIG. 1 is a cross-sectional view of a first prior art reflective LCD device with a photovoltaic cell.

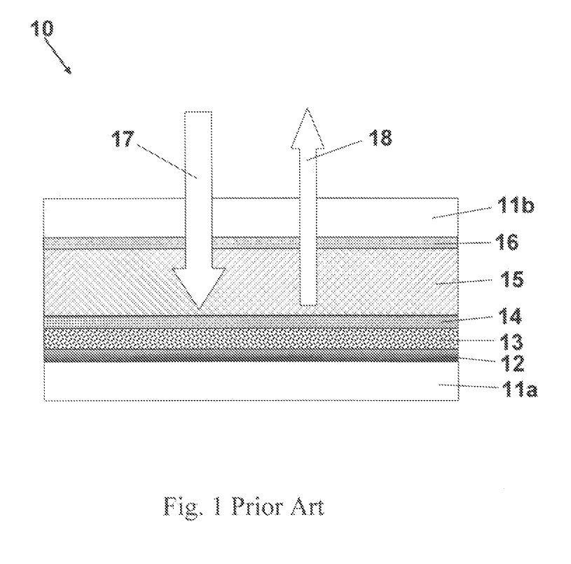

FIG. 2 is a cross-sectional view of a second prior art reflective LCD device with a photovoltaic cell and a band pass reflector.

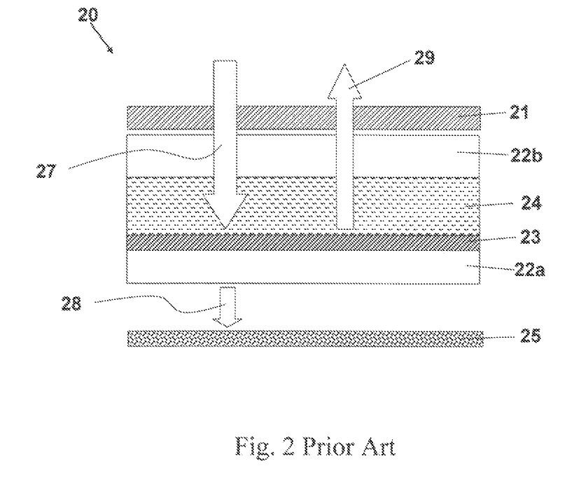

FIG. 3 is a cross-sectional view of a third prior art reflective LCD device with a photovoltaic cell and a switchable transflector.

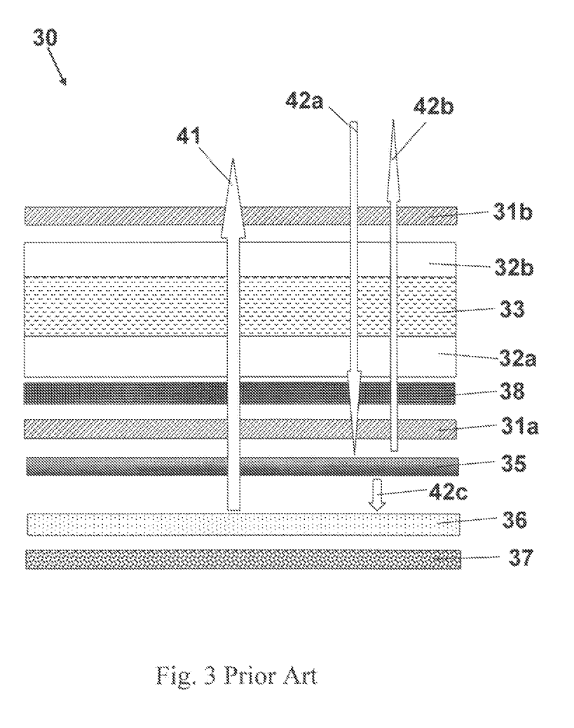

FIG. 4 is a cross-sectional view of a first preferred embodiment of the transflective LCD device with a photovoltaic cell.

FIG. 5a shows a top view of the first embodiment of the transflective LCD device with a photovoltaic cell.

FIG. 5b is a schematic diagram showing an equivalent circuit of present invention.

FIG. 6 is an illustration showing the light sources for the photovoltaic cell in the first embodiment.

FIG. 7 is a cross-sectional view of a second preferred embodiment of the transmissive LCD device with a photovoltaic cell.

FIG. 8 is a top view of the transmissive LCD device with a photovoltaic cell shown in FIG. 7.

FIG. 9 is an illustration of the light sources for the photovoltaic cell shown in FIG. 7.

### DESCRIPTION OF THE PREFERRED EMBODIMENTS

Before explaining the disclosed embodiments of the present invention in detail, it is to be understood that the invention is not limited in its application to the details of the particular arrangements shown since the invention is capable of other embodiments. Also, the terminology used herein is for the purpose of description and not of limitation.

The following is a list of the reference numbers used in the drawings and the detailed specification to identify components:
10 reflective LCD
11a first substrate
11b second substrate
12 reflective electrode
13 photovoltaic cell
14 transparent electrode
15 LC layer
16 electrode
17 ambient light
18 left part
20 reflective LCD
21 top polarizer
22a first substrate
22b second substrate
23 reflector
24 LC cell
25 photovoltaic cell
27 ambient light
28 transmitted light
29 reflected light
30 display pixel
31a bottom linear polarizer
31b top linear polarizer
32a bottom substrate
32b top substrate
33 LC layer
35 transflector
36 backlight
37 photovoltaic cell
38 color filter
41 backlight light
42a ambient light
42b reflected light
42c transmitted light
100 pixel
101a bottom linear polarizer
101b top linear polarizer
102a bottom transparent substrate
102b top substrate
103 liquid crystal layer
104 reflector
105 photovoltaic cell
108 backlight unit
110a transmitting region
110b blocking region
111 blocked light
112 transmitted light
113 incoming ambient light
114 reflected ambient
130 transmissive LC region
131a gate line of pixel
131b gate line adjacent pixel
132 data line
133 thin-film-transistor
135 storage capacitor region
136 pixel electrode
137 pixel region
140 reflective LC region
141 thin-film-transistor
142 gate line
143 data line
144 LC Capacitor
145 storage capacitor
200 pixel
201a bottom linear polarizer
201b top linear polarizer
202a bottom substrate
202b top substrate
203 LC layer
205 photovoltaic layer
208 backlight
210a light transmitting region
210b light blocking region
211 backlight emission
212 backlight emission
213 ambient light
230 transmitting region
231a gate line
231b gate line
232 data line
233 thin-film-transistor
235 storage capacitor
237 pixel region

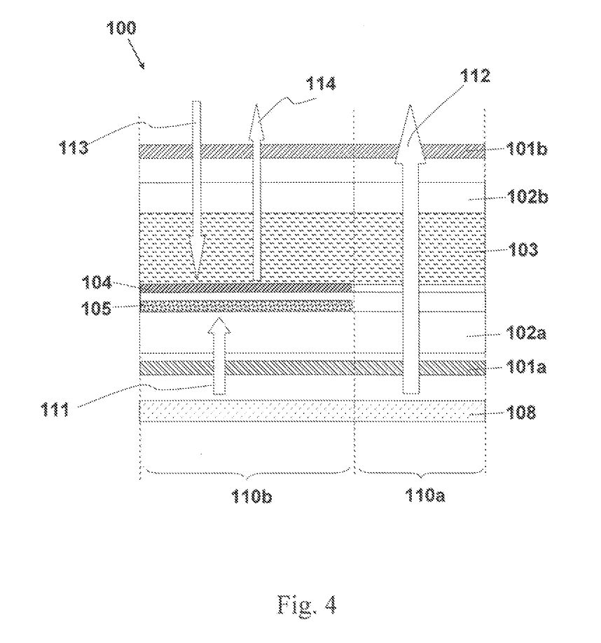

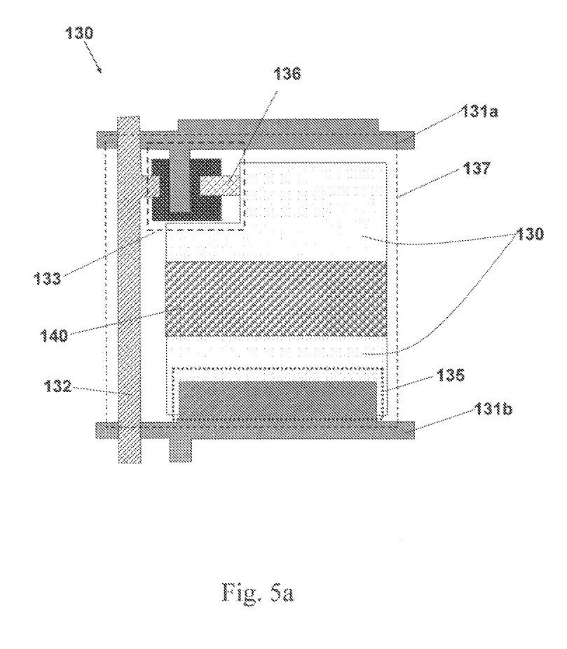

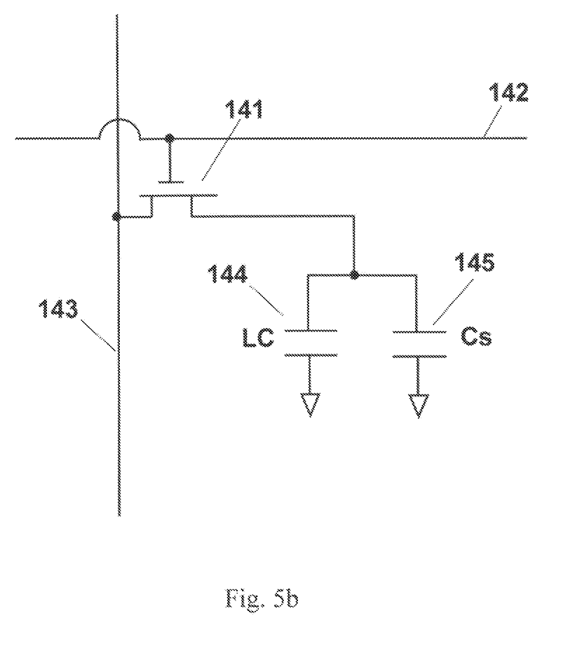

FIG. 4 shows the cross-sectional view of one repetitive pixel 100 of the present invention related to a liquid crystal display with an embedded photovoltaic cell. A liquid crystal layer 103 is formed between the bottom transparent substrate 102a and the top transparent substrate 102b. Additional alignment layers (not shown) like polyimide materials are formed on the interior surfaces of the two substrates. The LC layer and the two substrates are further interposed between a bottom linear polarizer 101a and a top linear polarizer 101b. Transparent electrodes and thin-film-transistors as shown in FIG. 5a provide the driving voltages to the LC cell. Below the bottom linear polarizer 101a, a backlight unit 108 is arranged to emit white light to the LC cell 103 and further to the viewer for displaying an image. In the configuration shown, the backlight can use an edge-lit configuration or a direct-lit configuration with sources like light cold cathode fluorescent lamps (CCFLs) or light emitting diodes (LEDs).

Each pixel is divided into two regions: region 110a that can transmit the light 112 from the backlight unit 108 to the viewer when the display is working under white mode (LC cell and the two polarizers pass the light), and region 110b that blocks the light 111 from the backlight unit 108, regardless of the working mode of the LC cell 103. In addition, on the bottom substrate 101a, a photovoltaic cell 105 made of semiconductor materials like silicon is formed to substantially cover the backlight blocking region 110b in each pixel.

A reflector 104 made of metals like aluminum and silver is also formed on the bottom substrate 101a to reflect the incident ambient light 113 to the viewer as reflected light 114, which functions for displaying images in the reflective mode. The backlight 108 transmitted into the backlight-blocking region 110b is absorbed by the PV cell 105 for charging the battery using charging circuits. As a benchmark, in a conventional transmissive LCD that does not have a reflector 104, the aperture ratio (the effective region that passes the light to the viewer from the backlight) is usually less than 50%, and the light 111 transmitted to the backlight-blocking region 110b is usually absorbed by the black-matrix (not shown), thus is wasted. Unlike the prior art, the configuration of the present invention, part of light 111 in the blocking region 110b can be used to illuminate the PV cell 105 for charging batteries.

The photovoltaic cell 105 shown is a device using semiconductor materials like silicon in the fundamental form of a p-n junction or in a multiple p-n junction structure, which can directly convert light into electricity. Two electrodes (not shown) are formed on two surfaces of the p-n junction structured photovoltaic cell 105, and the two electrodes are further connected to external circuits for charging the battery. Light impinging on the PV cell produces both a current and a voltage to generate electric power. First, the light is absorbed to raise electrons and stimulate them to a higher energy state, then these electrodes move from the PV cell to an external circuit. The electrons then dissipate their energies into the external circuits (for example, the energy is directed to charge the external batteries) and return to the PV cell again. The process can repeat as long as light is continuously impinging on the surface of the PV cell 105 and the PV cell 105 is connected to the external circuits in a closed loop.

In the configuration of the present invention, the backlight-blocking region 110b shown in FIG. 4 is different from the region covered by the reflector 104 in each pixel of the display. A detailed top view of each repetitive pixel region is shown in FIG. 5a. Each repetitive pixel region is shown as the region 137, which has a thin-film-transistor 133, a data line 132, a gate line 131a, a transmissive LC region 130, a reflective LC region 140, and a storage capacitor region 135. Gate line 132b shown in FIG. 5a is the gate line for the adjoining pixel that is not shown. The TFT 133 is made of amorphous silicon of poly-silicon technology, which functions as a switch for turning on and off the LCs in the pixel region. The switching signal comes from the gate line 131a, and driving voltage comes from a data line 132 that is connected to the drain (or source) region of the TFT 133. The other end source (or drain) region is connected to the pixel electrodes 136 of the LC cell. Once a pulse voltage is applied to the gate line 131, the TFT is turned on, and driving voltage related to the required gray level of this pixel comes from the data line to the pixel electrode 136, further onto the LCs to change the deformation of the LC molecular distribution, and light can be tuned to the transmission of that gray level.

With color filters (not shown) laminated on one of the interior surfaces of the LC cell, a specific color can be displayed. At the same time, the driving voltage from the data line 132 is also applied onto the storage capacitor 135 to store the electric charges which can help the LC cell 103 hold the voltage for a longer length of time. An illustration of the equivalent circuit of the display is shown in FIG. 5b. The data line 143 is connected to one end of the TFT 141 and the other end of the TFT is connected to the liquid crystal cell capacitor 144 and the storage capacitor 145, where the thin-film-transistor 141 is controlled by the gate line 142. The LC cell capacitor 144 is connected in parallel with the storage capacitor 145.

Referring to FIG. 5a, because the active region of TFT 133 is sensitive to external light, the total pixel region 137 is usually covered by a black-matrix on the top substrate 102b which is opaque to impinging light. As a result, its current-voltage characteristics are not affected by external light. The data line 132 and gate line 131a are usually made of the metals or alloys like one of the MoW, the alloy Al—Nd, or a stacked layer of Mo/Al materials that are not transparent to light. One of the surfaces of the storage capacitor is also made of metal and is also opaque.

Therefore, in the total pixel region 137, the total effective region with light for displaying images is the transmissive region 130 which is transparent to the backlight and ambient light and the reflective region 140 which is transparent to ambient light but not to backlight. Nevertheless, as shown in FIG. 4, for the backlight, the effective transmissive region is only the transmissive LC region 130, which is usually less than 60% of the total pixel area. In other words, in a conventional transmissive display, for the backlights impinging onto the LCs from the backplane, only less than 60% of the aperture area is transmissive, which is a big loss. But in the configuration of the present invention the part of light that might not pass to the LC cell in the conventional configuration is now re-directed to the photovoltaic cell 105 for charging the batteries, which in turn can be used to drive the backlight sources.

For the LC cell 103 shown in FIG. 4, the LCD works as a transflective LCD that has both transmissive and reflective functions in one cell. Normally white modes like a twist-nematic (TN) LC cell or normally black modes like a vertical alignment mode, an in-plane switching mode, or homogeneous LC cell can be employed for the LC cell. In all these configurations with different LC modes, additional compensation films like discotic films for TN cell and homogeneous cells, uniaxial polymer films and biaxial polymer films for VA cells might be used to expand the viewing angle as well.

The ratio of the reflective region 140 to the transmissive region 130 (R/T) in FIG. 5a can be varied according to different application requirements. For example, if the display operates mostly under environments with strong sunlight, a larger reflective region with a large R/T ratio like approximately 8:2 can be used. On the other hand, if the display is mainly operated under environments with low ambient, like in a common office, the area of the transmissive region could be larger, for example, a R/T ratio of approximately 2:8.

According to the performance of the configuration shown in this embodiment, the light incident from the backlight unit 108 is unpolarized before it reaches the surface of the bottom linear polarizer 101a. As a result, only about 50% of the light can pass through the bottom linear polarizer 101a. However, if backlight recycling is employed by methods such as arranging a reflective polarizer like a wire grid polarizer located below the bottom linear polarizer, a factor of approximately 1.6× improvement can be achieved for the light to pass the bottom linear polarizer.

Usually as discussed above, according to the opaque regions from the black-matrix covered TFT area, metal data and gate lines, storage capacitor, the effective region for light transmission and reflection (the sum of the reflective region 140 and the transmissive region 130) usually takes less than 60% of the total pixel area 137. For example, if in the effective region, the reflective region 140 and the transmissive region 130 take an area ratio of 1:1, then backlight-blocking region 110b in the pixel would be larger than approximately 70% which includes 40% from the non-effective regions including the black matrix covered areas and other opaque area, and 30% from the effective regions which is the reflective region. As a result, approximately 56% (in this example 56%=70%×50%×1.6) of the incident light from the bottom backlight unit can be used to illuminate the PV cell, which is relatively high in practical applications.

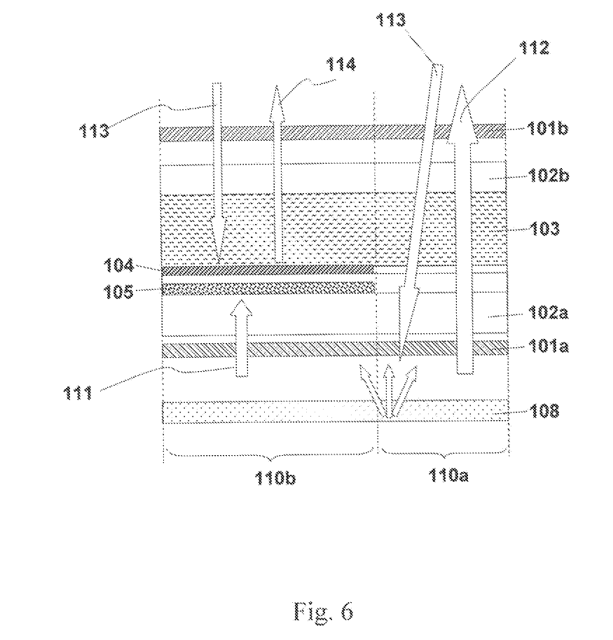

As a comparison, in prior arts, the efficiency of ambient light after it passes the two sheet linear polarizers and further to the PV cell at the backplane of the backlight unit is less than 4%. In practical applications, the ambient light can also contribute to the light source for the PV cell 105. As shown in FIG. 6, the ambient light 113 can penetrate the LC cell 103 all the way to the backlight unit 108. Because of the diffusers (not shown) employed in the backlight system, the ambient light 113 is scattered in different directions after it is reflected back by the reflective sheet (not shown) of the backlight unit 108, and part of it can propagate to the PV cell above, although the light efficiency of this part of the light would be low, less than approximately 4%.

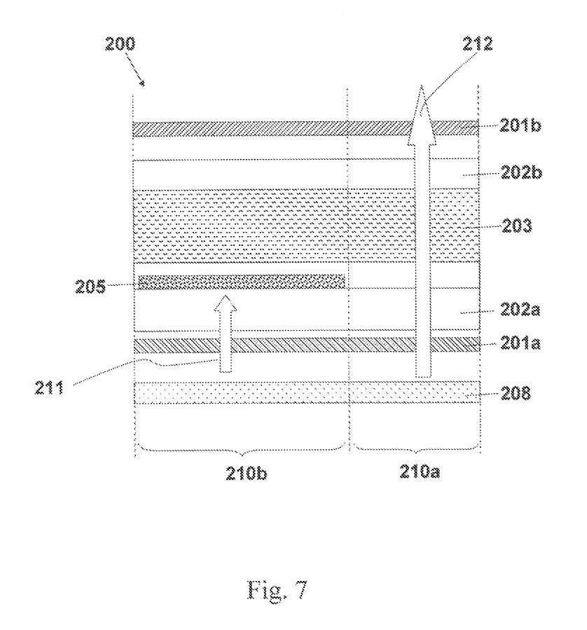

In the preferred embodiment shown in FIG. 7, a reflective region is not employed in the effective LC pixel. As shown, the repetitive pixel 200 of the display comprises a liquid crystal layer 203, a bottom substrate 202a and a top substrate 202b. Additional alignment layers (not shown) like polyimide materials are formed in the interior surfaces of the two substrates. The LC cell and the two substrates are further interposed between two linear polarizers 201a and 201b, where the top linear polarizer 201b is located at the viewer's side. A backlight unit 208 is placed at the backplane of the LC cell which is below the bottom linear polarizer 201a. The backlight unit 208 emits white light to the LC cell 203 and further to the viewer for displaying an image. In this embodiment the backlight 208 can use an edge-lit configuration or a direct-lit configuration with sources like light cold cathode fluorescent lamps (CCFLs) or light emitting diodes (LEDs).

Similarly, in each pixel, the pixel region is divided into two regions: region 210a that transmit the light 212 from the backlight unit 208 to the viewer when the LCD is working under a white mode, and region 210b that blocks the light 211 from the backlight unit 208 by the opaque regions of the pixel like black matrix, regardless of the working mode of the LC cell 203. On the bottom substrate 201a, a photovoltaic cell 205 made of semiconductor materials like silicon is formed to substantially cover the backlight blocking region 210b in each pixel. The backlight 211 emission into the backlight-blocking region 210b is absorbed by the PV cell 205 for charging the battery by certain charging circuits (not shown). The PV cell 205 in this example is a device using semiconductor materials like silicon in the fundamental form of a p-n junction, which can directly convert light into electricity.

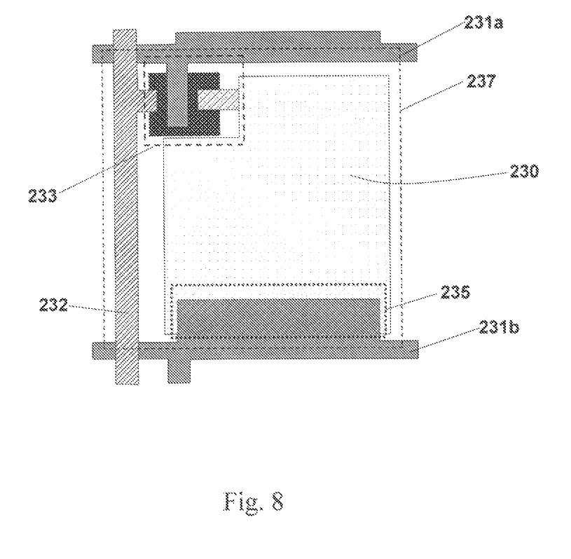

A detailed top view of each repetitive pixel region 237 is shown in FIG. 8. Each repetitive pixel region includes a thin-film-transistor (TFT) 233, a data line 232, a gate line 231a, a transmissive LC region 230, and a storage capacitor region 235. Gate line 231b is the gate line for the adjacent pixel that is not shown. The thin-film-transistor 233 is made of amorphous silicon of poly-silicon technology, and functions as a turn-on/off switch for the LC cell in pixel region. The pixel switching signal is provided by the gate line 231a and driving voltage is provided by the data line 232 connected to the drain (or source) region of the thin-film-transistor 233. The other end of the source (or drain) region is connected to the LC pixel electrodes. Once a high pulse voltage is applied to the gate line 231, the TFT is turned on, and driving voltage related to the required gray level of this pixel is transferred from the data line to the LC cell to change the deformation of the LC molecular distribution. With color filters (not shown) laminated in the interior surfaces of the LC cell, a specific color can be displayed. Meanwhile, the driving voltage from the data line is also applied onto the storage capacitor 235 for storing the electric charges, which can be used to help the LC cell hold the voltage for a longer length of time.

Similarly, as shown in FIG. 8, only part of its area (region 230) out of the total pixel region 237 passes light incident from the backlight unit 208 at the backplane. The TFT region 233 needs to be covered by black matrix (not shown) on the top substrate 202b as a shield from the external light which could change the current-voltage characteristics resulting in undesirable driving behaviors. In addition, the data line 232, the gate line 231a, and the storage capacitor 235 are usually made from opaque metal or alloy materials like one of the MoW, the alloy Al—Nd, or a stacked layer of Mo/Al materials. Thus, the effective region 230 is usually less than 60% of the total pixel region 237. In other words, in a conventional transmissive display, aperture ratio for transmission is less than 60%, which is a big loss for the backlight incident from the bottom. In the second embodiment of the present invention, this loss of light that results from the low aperture ratio in the conventional configuration can be reduced, because the light under the black regions is now directed to the photovoltaic cell 205 for charging the batteries, which in turn can be used to drive the backlight sources.

For the LC cell 203 in FIG. 8, the LCD works as a transmissive LCD that relies on the backlight to display the images. LC modes like a twist-nematic (TN) LC cell, a vertical alignment mode, an in-plane switching mode, or a homogeneous LC cell can be employed. Besides, in all these configurations with different LC modes, additional compensation films like discotic films for TN cell and homogeneous cells, uniaxial polymer films and biaxial polymer films for VA cells might be used to expand the viewing angle as well.

According to the performance of the configuration shown in this embodiment, about 32% (in this example 32%=40%×50%×1.6) of the total backlight incident from the bottom backlight unit 208 can be used to illuminate the PV cell 205, which is relatively high in practical applications. The number is derived from the following accumulation: first, the linear polarizer 201a causes a loss of approximately 50% for an unpolarized light incident from bottom, but when a reflective polarizer like a wire grid polarizer or polymer films is used, the light from the backlight passing the bottom linear polarizer 201a could be enhanced by about 1.6× to approximately 50%×1.6=80%. Second, according to the 60% aperture ratio of the display, the PV cell covers about 40% of the backlight blocking region. Therefore, the light to the PV cell in total can be about 32%. As a comparison, in prior arts, the efficiency of ambient light after it passes the two sheet linear polarizers and further to the PV cell at the backplane of the backlight unit is less than 4%.

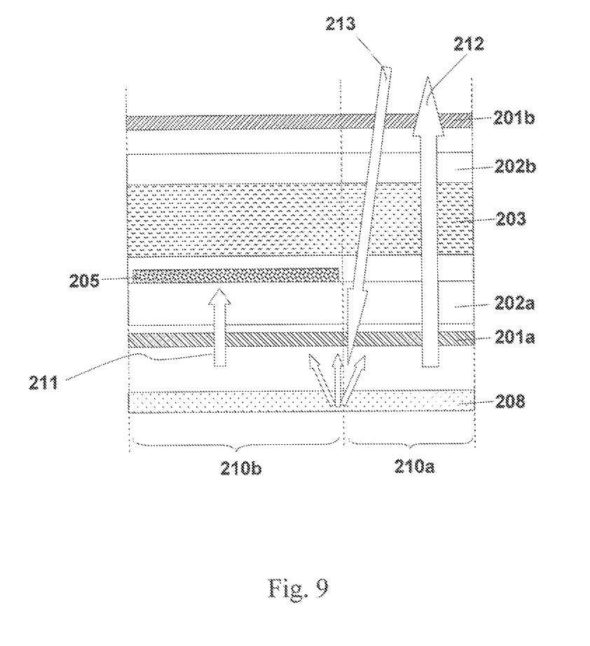

For the PV cell, the light from backlight unit at the backplane of the LC cell is major light source. However, the light from the incoming ambient can also be used to charge the PV cell. As shown in FIG. 9, the ambient light 213 passes through the LC cell 203 and travels to the backlight unit 208. Because of the diffusers (not shown here) in the backlight system, the light 213 is scattered before it reaches the reflective sheet in the backlight unit 208. After reflection, part of the light 213 can transmit to the PV cell 205. Although this light efficiency is pretty low, usually less than 4%, it provides an additional light source for charging the PV cell.

In summary, the LCDs of the present invention with embedded photovoltaic cell can convert light which was previously lost due to the low aperture ratio of the display as the light source of the PV cell, which in turn charges the batteries via external circuits. Additionally, part of the ambient light can also be directed to the PV cell after it passes the backlight system and is reflected. As a result, the energy efficiency of the display is greatly enhanced. In one embodiment, the display works in a transflective LCD configuration that has both transmissive and reflective functions. In another embodiment, the display works in a pure transmissive LCD configuration that relies on the backlight unit to display images.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

We claim:

1. A transflective liquid crystal display with a photovoltaic cell comprising:
a lower transparent substrate having a first linear polarizer laminated on an exterior surface;
an upper transparent substrate having a second linear polarizer laminated on an exterior surface, the upper substrate positioned adjacent to a viewer;
a liquid crystal layer sandwiched between the lower and upper substrates; and
a backlight unit adjacent to the first linear polarizer laminated on exterior surface of the lower substrate;
plural pixel regions between the upper and lower substrates, each pixel comprising:
a first sub-region having a data line and a gate line connected to a thin-film-transistor to switch the pixel, a storage capacitor and a reflector between the first substrate and the liquid crystal layer, the reflector reflecting ambient light to display images;
a photovoltaic cell formed in the first sub-region between the lower substrate and the reflector, the light from the backlight in the first sub-region striking the photovoltaic cell; and
a second sub-region having transparent electrodes on at least one of the upper and lower transparent substrates for driving the pixel, the second sub-region transmitting light from the backlight unit through the liquid crystal layer for displaying images while part of the ambient light passing the through the second sub-region toward the backlight unit is scattered and redirected to the photovoltaic cell.

2. The transflective liquid crystal display with a photovoltaic cell of claim 1, wherein the photovoltaic cell is made of active photovoltaic materials including amorphous silicon materials in a single p-n junction or multiple p-n junction structure.

3. The transflective liquid crystal display with a photovoltaic cell of claim 1, wherein the said transparent electrodes in the transmissive region are made of conductive materials including indium-tin-oxide and indium-zinc-oxide.

4. The transflective liquid crystal display with a photovoltaic cell of claim 1, wherein the reflector is made of one of aluminum and silver.

5. The transflective liquid crystal display with a photovoltaic cell of claim 1, wherein the ratio between the first sub-region and the second sub-region is adjusted from approximately 2:8 to approximately 8:2.

6. The transflective liquid crystal display with a photovoltaic cell of claim 1, wherein the said liquid crystal cell is one of a twist-nematic cell, a homogeneous cell, and a vertical alignment cell.

7. The transflective liquid crystal display with a photovoltaic cell of claim 6, wherein the said liquid crystal cell has at least one compensation film selected from a group consisting of discotic film, uniaxial film, and biaxial film.

8. A method for fabricating a transflective liquid crystal display with an embedded photovoltaic cell comprising the steps of:
providing a first and second substrate;
laminating a linear polarizer on an exterior surface of the first and the second substrate;
depositing a color filter on the second transparent substrate;
interposing a liquid crystal layer between the first substrate and the second substrate as a liquid crystal cell having a plurality of pixels defined therein;
forming each of the plural pixels consisting of the steps of:
forming a transparent pixel electrode on an interior surface of the first transparent substrate and a transparent common electrode on an interior surface of one of the first and second transparent substrates;
forming a thin-film transistor, a gate line and a data line on the first substrate, the gate line and the data line each connected to one of the source and the drain of the thin-film-transistor;
forming a photovoltaic cell on a portion of the first transparent substrate in each pixel region to form a reflective sub-region; and
depositing a reflector between the photovoltaic cell and the liquid crystal layer in the reflective sub-region; and
disposing a backlight unit below the first substrate, the light emitted from the backlight unit striking the photovoltaic cell in the reflective sub-region and transmitting through the liquid crystal cell the remaining transmission sub-region.

9. The method of claim 8 further comprising the steps of:
depositing an alignment layer on the interior surfaces of the first and second substrates;
connecting the data line and gate line to an external driving circuit; and
connecting the photovoltaic cell to an external charging circuit to charge a battery.

10. The method of claim 8 further comprising the step of:
depositing a color filter on the second transparent substrate.

11. A transmissive liquid crystal display with a photovoltaic cell comprising:
a lower transparent substrate;
an upper transparent substrate positioned for viewing by a viewer;
a first and second linear polarizer laminated on an exterior surface of the lower and upper substrate, respectively;
a backlight unit positioned adjacent to the first linear polarizer on the exterior surface of the lower substrate; and
a liquid crystal layer between the lower and upper substrates forming a plurality of pixel regions between the upper and lower substrates, each pixel region comprising:
a first sub-region having a data line and a gate line each connected to one of a thin-film-transistor drain and source and a storage capacitor;
a black matrix between the upper substrate and the liquid crystal layer covering a portion of each pixel to block light from the backlight unit;
a photovoltaic on the lower substrate aligned with the black matrix to absorb light from the backlight unit; and
a second sub-region having transparent pixel and common electrodes on at least one of the lower and the upper substrate for driving the liquid crystal cell and transmitting light incident from the backlight unit through the liquid crystal cell to display images, the ambient light passing through the second sub-region of the pixel scattering with a portion of the scattered light striking the photovoltaic.

12. The transmissive liquid crystal display with a photovoltaic cell of claim 10 further comprising:
a color filter laminated on the upper transparent substrate.

13. The transmissive liquid crystal display with a photovoltaic cell of claim 10, wherein the photovoltaic cell is made of an active photovoltaic materials including amorphous silicon material in a single p-n junction or multiple p-n junction structure.

14. The transmissive liquid crystal display with a photovoltaic cell of claim 10, wherein the transparent electrodes in the transmissive region are made of a conductive material including indium-tin-oxide or indium-zinc-oxide.

15. The transmissive liquid crystal display with a photovoltaic cell of claim 10, wherein the said liquid crystal cell is one of a twist-nematic cell, a homogeneous cell, and a vertical alignment cell.

16. The transmissive liquid crystal display with a photovoltaic cell of claim 15, wherein the said liquid crystal cell includes a compensation film selected from a discotic film, uniaxial film, and biaxial film.

17. A method for fabricating the transflective liquid crystal display with a photovoltaic cell comprising the steps of:
constructing a liquid crystal cell having a first substrate and a second substrate separated by a distance;
laminating a first and second linear polarizer on the exterior surface of the first and second substrate, respectively;
forming a plurality of pixels between the first and second substrate, each pixel having a thin-film-transistor and a data line and a gate line;
depositing black-matrix on a portion of the second transparent substrate;
forming transparent pixel electrodes on the first transparent substrate and a transparent common electrodes on one of the first and second transparent substrate;
connecting the data line and the gate line to one of the source and drain of the thin-film-transistor and connecting pixel electrode to the gate of the thin-film-transistor;
forming a photovoltaic cell on the portion of the first transparent substrate parallel with the black-matrix in each pixel region;
interposing a liquid crystal layer between the first substrate and the second substrate;
disposing a backlight unit below the first transparent substrate, the photovoltaic converting part of the backlight emission into electrical energy.

18. The method of claim 17 further comprising the step of:
depositing a color filter on the second transparent substrate; and
depositing alignment layers on the interior surfaces of the first and second substrates.

19. The method of claim 17 further comprising the step of:
connecting the data line and gate line to external driving circuit; and
connecting the photovoltaic cell to external charging circuit to charge the battery.
